(19) United States
(12) Patent Application Publication
(10) Pub. No.: US 2016/0055105 A1
(43) Pub. Date: Feb. 25, 2016

(54) ELECTRONIC DEVICE AND METHOD FOR AVOIDING MUTUAL INTERFERENCE BETWEEN MULTIPLE INPUT DEVICES

(71) Applicant: Quanta Computer Inc., Taoyuan City (TW)

(72) Inventors: Ta-Jen Hsieh, Taoyuan City (TW); Ying-Tsang Lin, Taoyuan City (TW); Yen-Chih Chen, Taoyuan City (TW)

(21) Appl. No.: 14/616,040

(22) Filed: Feb. 6, 2015

(30) Foreign Application Priority Data
Aug. 20, 2014 (TW) 103128592

(51) Int. Cl. G06F 13/22

(52) U.S. Cl. CPC G06F 13/225

(57) ABSTRACT

A method for avoiding mutual interference between multiple input devices is provided. The method is applied to an electronic device. The method includes: setting corresponding priority for multiple input devices of the electronic device according to a priority setting result; determining whether any other input device is functioning when a first input event of a first input device is received; and when a second electronic device is functioning, determining whether to process or ignore the first input event according to the priority of the first input device and the priority of the second input device. When the priority of the first input device is higher than that of the second input device, the first input event is processed. When the priority of the second input device is higher than that of the first input device, the first input event is ignored.

### CROSS REFERENCE TO RELATED APPLICATIONS

This Application claims priority of Taiwan Patent Application No. 103128592, filed on Aug. 20, 2014, the entirety of which is incorporated by reference herein.

### BACKGROUND OF THE INVENTION

1. Field of the Invention

The invention relates to a method for avoiding mutual interference between multiple input devices of an electronic device.

2. Description of the Related Art

Touch technologies are commonly used in input devices of a variety of products, such as the panels of cellular phones, Personal Digital Assistants (PDA), tablet PCs and wireless flat panel displays (FPD), etc. Some of these products further support multiple input devices, such as a touch screen, a digitizer (and the corresponding electromagnetic pen), a stylus, a keyboard, a mouse and the like.

Generally, the input devices can be used anytime. However, when the input devices are used for controlling system operations at the same time, interference occurs between different control methods, which may cause system data error.

Therefore, a method for avoiding interference between multiple input devices of an electronic device is highly required.

### BRIEF SUMMARY OF THE INVENTION

Electronic devices and methods for avoiding mutual interference between multiple input devices are provided. An exemplary embodiment of an electronic device comprises a first input sensor, a second input sensor and a processor. The first input sensor senses at least a first input event of a first input device. The second input sensor senses at least a second input event of a second input device. The processor sets a priority of the first input device and a priority of the second input device according to a priority setting result. When the processor receives the first input event and the second input event in turn, the processor determines which input device has a higher priority, and when the priority of the first input device is higher than the priority of the second input device, the processor processes the first input event and ignores the second input event, and when the priority of the second input device is higher than the priority of the first input device, the processor processes the second input event and ignores the first input event.

In an embodiment of the invention, the electronic device further comprises a touch panel, wherein the first input device is the touch panel and the first input sensor is a touch sensor.

In an embodiment of the invention, the electronic device further comprises a digitizer, wherein the second input device is the digitizer and the second input sensor is a digitizer sensor.

In an embodiment of the invention, the electronic device further comprises an input/output port coupled to a third input device, wherein the processor receives at least a third input event of the third input device via the input/output port and sets the priority of the first input device, the priority of the second input device and a priority of the third input device according to the priority setting result.

In an embodiment of the invention, the processor dynamically determines the priority of each input device according to an application program currently launched by a user to generate the priority setting result.

An exemplary embodiment of a method applied to an electronic device for avoiding mutual interference between multiple input devices comprises: setting a priority of a plurality of input devices of the electronic device according to a priority setting result; determining whether any other input device is functioning when receiving a first input event of a first input device; and when a second input device is functioning, determining whether to process or ignore the first input event according to the priority of the first input device and the priority of the second input device, wherein when the priority of the first input device is higher than the priority of the second input device, the first input event is processed, and when the priority of the second input device is higher than the priority of first input device, the first input event is ignored.

In an embodiment of the invention, the method further comprises determining the priority of each input device according to a preference of a user of the electronic device to generate the priority setting result.

In an embodiment of the invention, the method further comprises dynamically determining the priority of each input device according to an application program currently launched by a user of the electronic device to generate the priority setting result.

In an embodiment of the invention, the method further comprises determining the priority of each input device according to an accuracy of each input device to generate the priority setting result.

In an embodiment of the invention, when receiving a second input event of the second input device, the method further comprises determining whether to process or ignore the second input event according to the priority of the first input device and the priority of the second input device, wherein when the priority of the first input device is higher than the priority of the second input device, the second input event is ignored, and when the priority of the second input device is higher than the priority of first input device, the second input event is processed.

In an embodiment of the invention, the method further comprises directly processing the first input event when there is no other input device functioning.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of an electronic device according to an embodiment of the invention;

FIG. 2 shows an exemplary flow chart for processing an input event in the electronic device;

FIG. 3 shows the flow chart of a method applied to an electronic device for avoiding mutual interference between multiple input devices according to an embodiment of the invention;

FIG. 4 shows an exemplary flow chart for processing an input event in the electronic device according to an embodiment of the invention; and

FIG. 5 shows another exemplary flow chart for processing an input event in the electronic device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

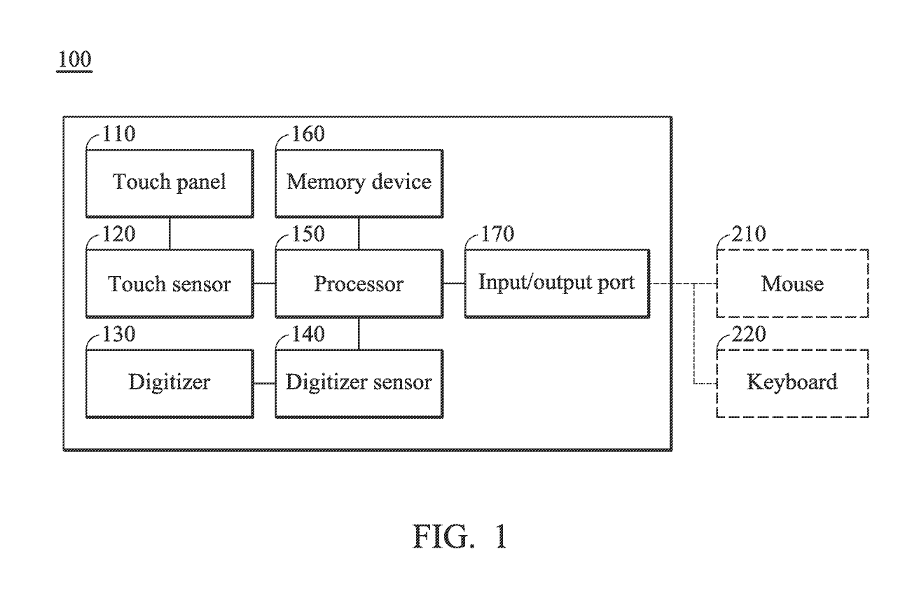

FIG. 1 shows a block diagram of an electronic device according to an embodiment of the invention. The electronic device 100 may be, for example, a cellular phone, a PDA, a tablet PC, a PC or other electronic device capable of supporting multiple input methods. According to an embodiment of the invention, the electronic device 100 may at least comprise a processor 150, a memory device 160 and a plurality of input devices. For example, the input devices of the electronic device 100 may comprise a touch panel 110 and the corresponding touch sensor 120 and a digitizer 130 the corresponding digitizer sensor 140. The touch panel 110 may be a touch controlled display panel having a display and touch-control functionality. The touch sensor 120 may sense the touch operations of user's finger or a stylus on the touch panel 110 and transmit information regarding the sensed touch operations to the processor 150 as the received input event. The digitizer 130 may attach to the touch panel 110 and provided as an input device with higher resolution/accuracy. The digitizer sensor 140 may be utilized to sense the operations of user via an electromagnetic pen on the digitizer, and transmit information regarding the sensed operations to the processor 150 as the received input event.

According to another embodiment of the invention, the electronic device 100 may further comprise an input/output port 170. Any external input device external to the electronic device 100 may be coupled to the electronic device 100 via the input/output port 170. The external input device may be, for example, the mouse 210 or keyboard 220. For example, the mouse 210 or keyboard 220 may be coupled to the input/output port 170 via a USB transmission line, and information regarding the operations of user on the mouse 210 or keyboard 220 may be transmitted to the processor 150 of the electronic device 100 via the USB interface as the received input event.

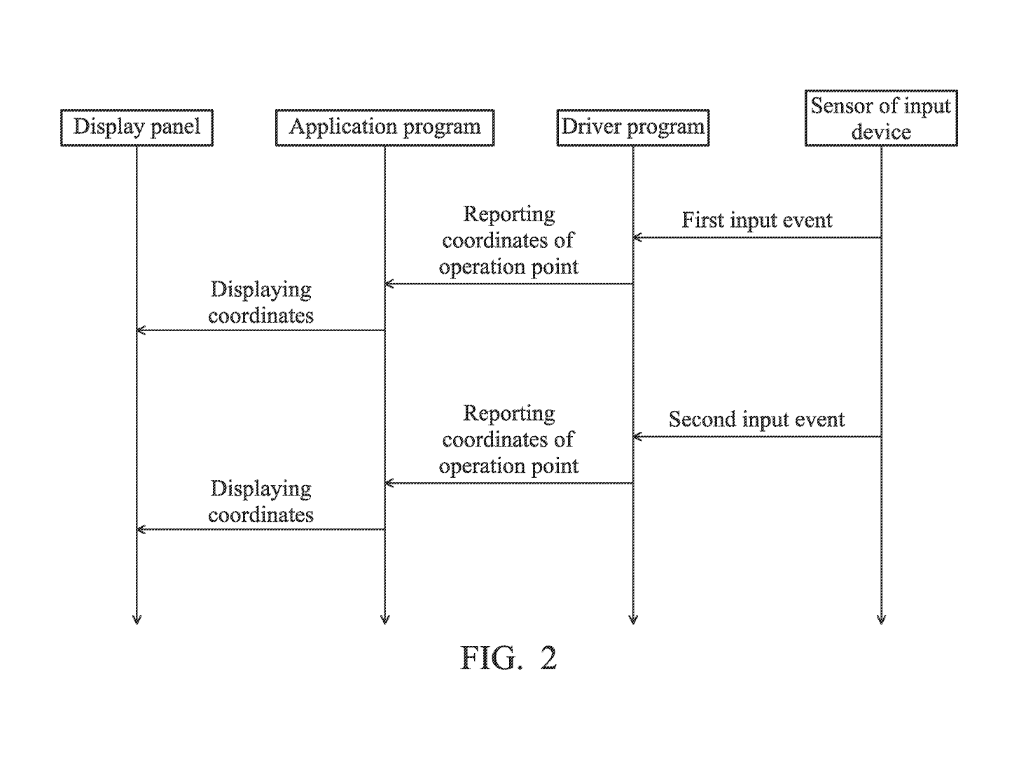

FIG. 2 shows an exemplary flow chart for processing an input event in the electronic device. As shown in FIG. 2, the sensor of an input device (such as the touch sensor 120, the digitizer sensor 140, the sensor embedded in the mouse 210 or keyboard 220, or the like) may transmit information regarding the sensed user operations on the corresponding input device (such as the absolute coordinates, relative coordinates, coordinate changes, or strength of pressure of the finger/stylus/electromagnetic pen, or others) to the corresponding driver program. The driver program may be firmware executed by the processor 150 as a bridge between the hardware device (such as the input device and the sensor of the corresponding input device) and the software. The driver program may further process the corresponding information after receiving the information regarding the input event, and transmit the data that must be displayed on the screen (for example, the coordinates of operation point on the screen) to the application program. The application program may be a software program executed by the processor 150 for collecting all the data to be displayed on the screen. Finally, the application program may display the current operation point (for example, shown as a cursor) on the screen of the display panel (for example, the touch panel 110) according to the received coordinates of the operation point.

As shown in FIG. 2, since the sensor of the input device may report the sensed input event anytime, when two input devices are used at the same time, mutual interference occurs. For example, the cursor may flick or shift when the application program receives the coordinates of two different input events within a short time. When operating the application programs that need high resolution/accuracy, the mutual interference may cause serious errors.

Therefore, in the embodiment of the invention, the processor 150 may set a corresponding priority for each input device according to a priority setting result. The priority may be the precedence to be processed by the processor 150 when two or more than two input devices are functioning at the same time. According to an embodiment of the invention, the user may set the corresponding priority for each input device according to the user's preference via a specific application program when the electronic device 100 is powered on to generate the priority setting result. According to another embodiment of the invention, the processor 150 may also set the priority for each input device according to an application program currently launched by a user to generate the priority setting result. In other words, in the embodiment of the invention, the priority of each input device may be dynamically adjusted according to the application program currently launched by the user. According to yet another embodiment of the invention, the processor 150 may also launch a specific application program according to user's operation. When the specific application program is launched or executed, a floating window may be displayed in any position on the screen of the electronic device 100 and provided for the user to adjust the priorities of the input devices anytime. The position of the floating window is not fixed and the window can be moved to any position that is assigned by the user according to user's operation. According to yet another embodiment of the invention, the specific application may further sort the resolution/accuracy of each input device, and display the information in a list as a reference for the user to set the priority of the input devices. For example, the accuracy of a digitizer is usually higher than a touch panel. Therefore, the user may select a most suitable input device according to the current requirement and set the highest priority to the input device.

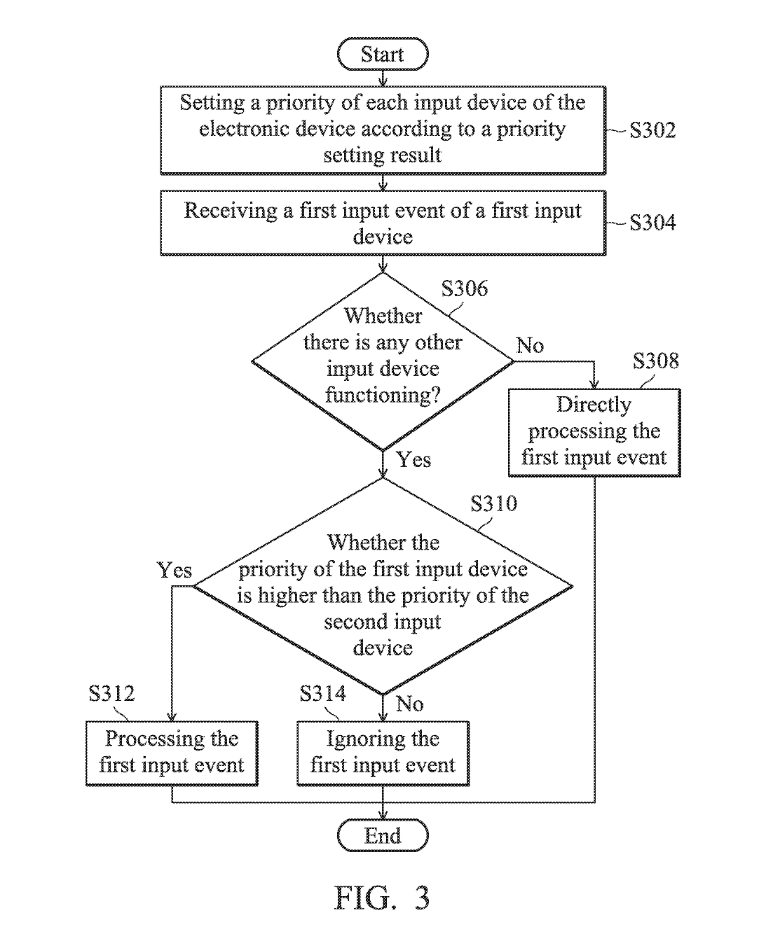

FIG. 3 shows the flow chart of a method applied to an electronic device for avoiding mutual interference between multiple input devices according to an embodiment of the invention. First of all, the processor 150 may set a priority of each input device of the electronic device according to a priority setting result (Step S302). Next, when the processor receives a first input event of a first input device (Step S304), the processor may determine whether there is any other input device functioning (Step S306). Here, “functioning” means that the other input device is receiving input from the user. In an embodiment of the invention, the processor 150 may determine whether there is any other input device functioning by inspecting whether there is any sub-thread is created for sensing, receiving, determining or processing the input events of other input devices, so as to determine whether there is any other input device functioning. When there is no other input device functioning, the processor 150 may directly process the first input event (Step S308).

On the other hand, when there is at least a second input device functioning, the processor 150 may further determine whether to process or ignore the first input event according to the priority of the first input device and the priority of the second input device. As shown in FIG. 3, the processor 150 may determine whether the priority of the first input device is higher than the priority of the second input device (Step S310). When the priority of the first input device is higher than the priority of the second input device, the processor 150 processes the first input event (Step S312). When the priority of the second input device is higher than the priority of the first input device, the processor 150 ignores the first input event (Step S314). In the embodiments of the invention, ignoring the input event may be that the processor directly discards the information or data regarding the input event and does not further process the information or data regarding the input event and does not show any information or data regarding the input event on the screen of the electronic device 100 (for example, the position of the cursor on the screen will not be changed in response to the input event). In other words, the electronic device 100 is unresponsive to the first input event.

According to an embodiment of the invention, when implementing the method, the processor 150 may create a main thread via a predetermined application program to receive information regarding the input event sensed by each input device and determine to process which input event via the main thread, so as to avoid mutual interference. Note that in an embodiment of the invention, the priority setting result may be stored in the memory device 160 and can be accessed anytime by the processor 150. In addition, when the system is powered off, the predetermined application program will close the main thread and selectively keep the priority setting result in the memory device 160, clear the priority setting result in the memory device 160, or recover the priority setting result to system default value.

Several exemplary flow charts are also introduced to illustrate the flow of processing the input events of the electronic device 100. Note that although the touch panel and digitizer are used as two exemplary input devices/control modes, the invention should not be limited thereto. The proposed methods and concepts can certainly be applied in any input device or control mode that is supported by each kind of electronic device 100.

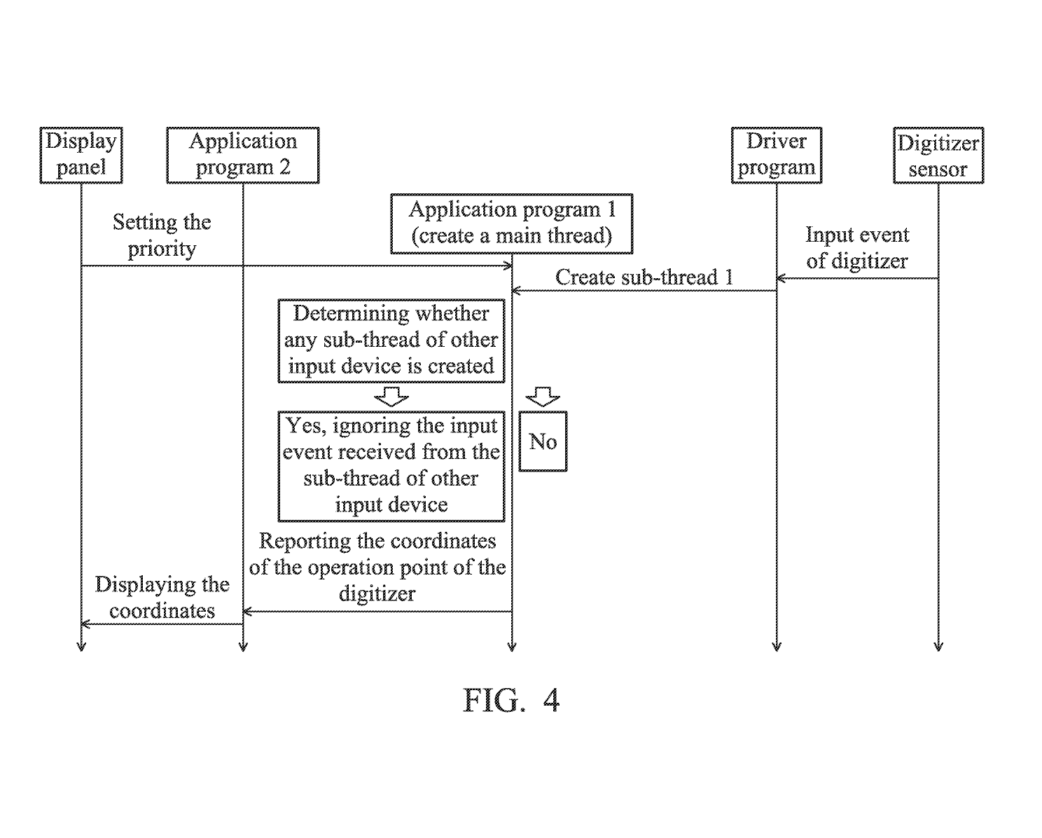

FIG. 4 shows an exemplary flow chart for processing an input event in the electronic device according to an embodiment of the invention. First of all, the processor 150 may execute the application program 1 to create a main thread and set the corresponding priority of each input device. The application program 1 may be a predetermined software application program executed by the processor 150 for receiving information regarding the sensed input event of each input device and determining which input event is to be processed on the instant via the main thread to avoid mutual interference.

In this embodiment, the application program 1 sets the priority of each input device according to the user's preference received from the user interface display on the display panel. However, it should be noted that the processor 150 may further set the priority of each input device according to other different methods as discussed above and the invention should not be limited thereto. Suppose that in this embodiment, the digitizer has the highest priority. When the digitizer sensor transmits information regarding the sensed operations of the user on the digitizer to the corresponding driver program, the driver program creates a specific sub-thread 1 to process the input events of the digitizer, which may comprise processing the corresponding data of the input event and transmitting the corresponding data needing to be displayed on the screen (for example, the coordinates of the operation point) to the application program 1.

Next, the application program 1 may further determine where there is any sub-thread created for another input device (that is, whether there is any other input device functioning). If not, the application program 1 directly reports the received coordinates of the operation point of the digitizer to the application program 2. The application program 2 may be another software program executed by the processor 150 for collecting all the data to be displayed on the screen. On the other hand, when there is any sub-thread created for other input devices at present, since the digitizer has the highest priority, the application program 1 ignores the input events received from the sub-thread of other input devices and reports the received coordinates of the operation point of the digitizer to the application program 2 when the digitizer is still functioning. Finally, the application program 2 displays the current operation point (for example, the cursor) on the screen of the display panel (for example, the touch panel 110) according to the received coordinates of the operation point.

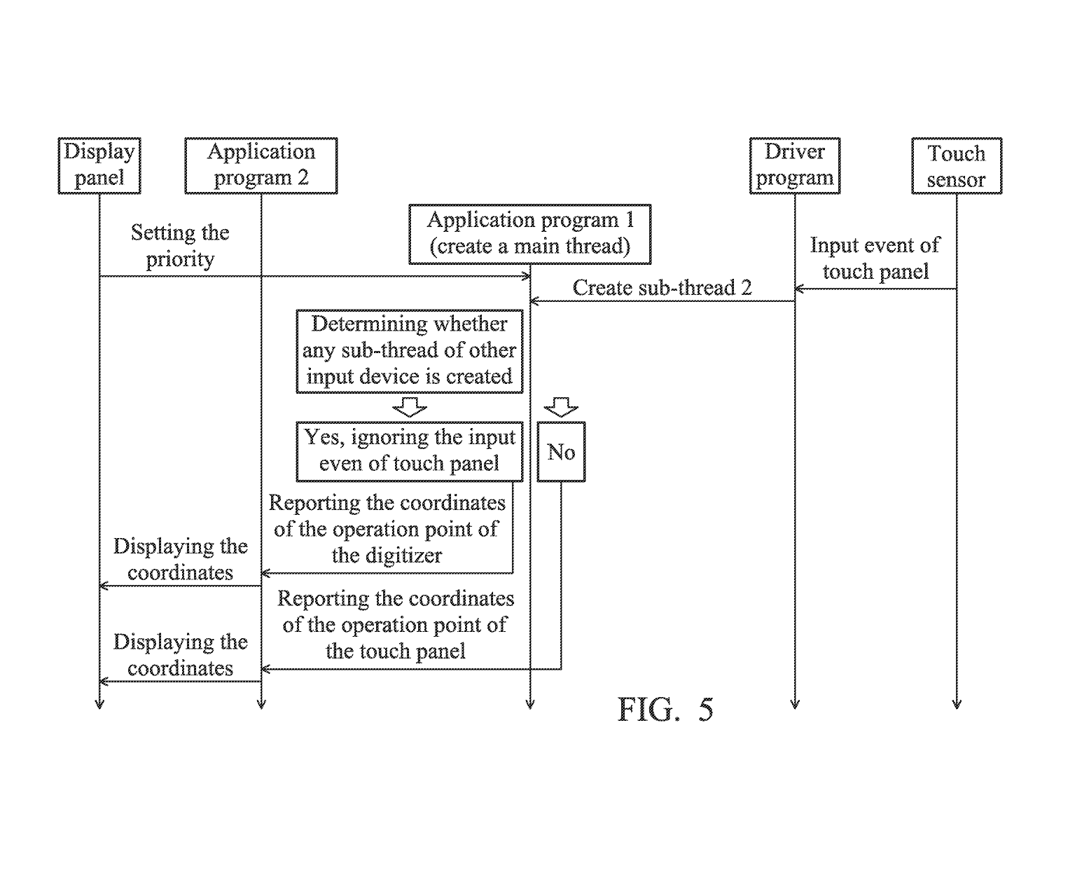

FIG. 5 shows another exemplary flow chart for processing an input event in the electronic device according to another embodiment of the invention. First of all, the processor 150 may execute the application program 1 to create a main thread and set the corresponding priority of each input device. The application program 1 may be a predetermined software application program executed by the processor 150 for receiving information regarding the sensed input event of each input device and determining which input event is to be processed on the instant via the main thread to avoid mutual interference.

In this embodiment, the application program 1 sets the priority of each input device according to the user's preference received from the user interface display on the display panel. However, it should be noted that the processor 150 may further set the priority of each input device according to other different methods as discussed above and the invention should not be limited thereto. Suppose that in this embodiment, the digitizer has the highest priority. When the touch sensor transmits information regarding the sensed operations of the user on the touch panel to the corresponding driver program, the driver program creates a specific sub-thread 2 to process the input events of the touch panel, which may comprise processing the corresponding data of the input event and transmitting the corresponding data needing to be displayed on the screen (for example, the coordinates of the operation point) to the application program 1.

Next, the application program 1 may further determine where there is any sub-thread created for other input devices (that is, whether there is any other input device functioning). If not, the application program 1 directly reports the received coordinates of the operation point of the touch panel to the application program 2. The application program 2 may be another software program executed by the processor 150 for collecting all the data to be displayed on the screen. On the other hand, when there is any sub-thread created for another input device, such as a digitizer, at present, the application program 1 compares which input device has the higher priority. Since the digitizer has the highest priority, when the digitizer is still functioning, the application program 1 ignores the input events received from the sub-thread of the other input device and reports only the received coordinates of the operation point of the digitizer to the application program 2. In other words, in this embodiment, when an input device with a higher priority is functioning, the application program 1 ignores information regarding the coordinates of the operation point of the touch panel. Finally, the application program 2 displays the current operation point (for example, the cursor) on the screen of the display panel (for example, the touch panel 110) according to the received coordinates of the operation point.

Note that in the embodiments of the invention, since each input device is set to have different priorities, when the input device with a lower priority is functioning and another input device with a higher priority is activated and begins to function, the processor 150 may directly terminate the function of the input device with a lower priority after receiving information regarding the input event of another input device with a higher priority and/or ignore the information regarding the input event of the input device with a lower priority received thereafter. In other words, when another input device with a higher priority is activated and begins to function, the electronic device 100 is unresponsive to the input event of the input devices with a lower priority. In this manner, the mutual interference between multiple input devices can be avoided and the optimum control between multiple input devices can be achieved.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

The proposed method, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a first input sensor, sensing at least a first input event of a first input device;
a second input sensor, sensing at least a second input event of a second input device; and
a processor, setting a priority of the first input device and a priority of the second input device according to a priority setting result,
wherein when the processor receives the first input event and the second input event in turn, the processor determines which input device has a higher priority, and when the priority of the first input device is higher than the priority of the second input device, the processor processes the first input event and ignores the second input event, and when the priority of the second input device is higher than the priority of the first input device, the processor processes the second input event and ignores the first input event.

2. The electronic device as claimed in claim 1, further comprising a touch panel, wherein the first input device is the touch panel and the first input sensor is a touch sensor.

3. The electronic device as claimed in claim 1, further comprising a digitizer, wherein the second input device is the digitizer and the second input sensor is a digitizer sensor.

4. The electronic device as claimed in claim 1, further comprising an input/output port coupled to a third input device, wherein the processor receives at least a third input event of the third input device via the input/output port and sets the priority of the first input device, the priority of the second input device and a priority of the third input device according to the priority setting result.

5. The electronic device as claimed in claim 1, wherein the processor dynamically determines the priority of each input device according to an application program currently launched by a user to generate the priority setting result.

6. A method applied to an electronic device for avoiding mutual interference between multiple input devices, comprising:
setting a priority of a plurality of input devices of the electronic device according to a priority setting result;
determining whether any other input device is functioning when receiving a first input event of a first input device; and
when a second input device is functioning,
determining whether to process or ignore the first input event according to the priority of the first input device and the priority of the second input device,
wherein when the priority of the first input device is higher than the priority of the second input device, the first input event is processed, and when the priority of the second input device is higher than the priority of first input device, the first input event is ignored.

7. The method as claimed in claim 6, further comprising:
determining the priority of each input device according to a preference of a user of the electronic device to generate the priority setting result.

8. The method as claimed in claim 6, further comprising:
dynamically determining the priority of each input device according to an application program currently launched by a user of the electronic device to generate the priority setting result.

9. The method as claimed in claim 6, further comprising:
determining the priority of each input device according to an accuracy of each input device to generate the priority setting result.

10. The method as claimed in claim 6, wherein when receiving a second input event of the second input device, the method further comprises:
determining whether to process or ignore the second input event according to the priority of the first input device and the priority of the second input device,
wherein when the priority of the first input device is higher than the priority of the second input device, the second input event is ignored, and when the priority of the second input device is higher than the priority of first input device, the second input event is processed.

11. The method as claimed in claim 6, further comprising:
when there is no other input device functioning, directly processing the first input event.
